(19) United States
(12) Patent Application Publication
(10) Pub. No.: US 2008/0150789 A1
(43) Pub. Date: Jun. 26, 2008

(54) Radar level gauge system

(76) Inventors: Anders Jirskog, Huskvarna (SE); Peter Dragen, Goteborg (SE)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/643,311

(22) Filed: Dec. 21, 2006

(51) Int. Cl. G01S 13/00

(52) U.S. Cl. 342/124

(57) ABSTRACT

A radar level gauge system for determining a filling level of a filling material in a tank is disclosed. The system comprises: a wave guide arranged within the tank; a signaling unit arranged outside the tank, and comprising a transmitter for transmitting measuring signals towards the surface of the filling material in said wave guide and a receiver for receiving echo signals from the tank, wherein the transmitter is preferably arranged to provide measuring signals of a frequency below 3 GHz. Further, a coaxial cable for forwarding the measuring signals and the echo signals between the wave guide and the signaling unit is provided, wherein the coaxial cable is of a length which is at least as long as the height of the tank. By means of this radar level gauge system, it becomes relatively easy and inexpensive to replace mechanical level gauge systems, so-called “float and tape systems”.

### FIELD OF THE INVENTION

The present invention relates to a radar level gauging system for determining a filling level of a filling material in a tank, and in particular a radar level gauge system that can be used for replacing existing old mechanical level gauging systems of the so-called float and tape type.

### BACKGROUND OF THE INVENTION

For at least a hundred years, mechanical systems have been used for determining filling levels in tanks housing e.g. liquids, such as in petroleum storage tanks, grain containers and containers for housing volatile liquids. Such known mechanical systems, commonly referred to as “float and tape systems” are e.g. disclosed in U.S. Pat. No. 2,904,998, 3,057,199, 3,148,542 and 4,459,584. Even though other alternative level gauging techniques have since been developed, such as radar level gauging, the old float and tape systems are still commonly used.

A typical float and tape system, as is illustrated in FIG. 1,basically consists of a metal tape 10, an in-line tube assembly 11, a take-up reel and a mechanical or electrical liquid level indicator. The take-up reel and level indicator is arranged within a housing 12, arranged exteriorly of the tank 15, and normally close to the ground, i.e. close to the base level of the tank. One end of the tape 10 is connected to a float 13, while the other is connected to the take-up reel. The tape is transported between the two termination points by e.g. wheel pulleys 14, wherein both the tape and wheel pulleys are enclosed within the in-line tube assembly. The in-line tube assembly commonly consists of a horizontal tube 11a and two vertical tubes 11b, c. One of the vertical tubes is attached to the top of the tank., while the other is attached to the tank-external housing 12. The housing also includes a mechanism or electronics that in combination with the take-up reel and float allows a liquid level 16 of the tank 15 to be determined. Within the tank, one or several guide wires 17 is arranged, extending vertically between the tank bottom and tank roof, for guiding of the float 13. Tape and float systems as used today normally has a receiver hard-wired to the electrical or mechanical apparatus, to allow the liquid level to be monitored at a remote station. To this end, the housing is normally connected to electrical wires, for transfer of data signals and electrical power for the measuring operation.

However, such mechanical systems are the subject of many problems. For example, the environment in the tanks is often relatively rough, making the movable mechanical parts likely to malfunction over time. Further, the floating member needs to be in contact with the fluid, which is disadvantageous since the surface is normally not still. Accordingly, these mechanical system have problems with robustness, accuracy and reliability. For these reasons, it is often advantageous to use non-contacting level gauging systems, such as radar level gauges. These devices utilize antennas to transmit electromagnetic waves toward the material being monitored and to receive electromagnetic echoes which are reflected at the surface of the material being monitored. Such systems could either use continuous transmitted signals, so-called FMWC (frequency modulated continuous wave) or pulsed transmitted signals. Examples of such radar level gauge systems are e.g. disclosed in WO 2004/018978 and U.S. Pat. No. 6,414,625.

In spite of the above-discussed problems of the tape and float systems, there is often a reluctance to replace these systems with e.g. radar level gauging systems, since transition costs involved are relatively high. Often, the replacement requires the provision of new installations on the tank roof, and extensive additional electrical field wiring is needed between the position of the old housing 12 and the antenna roof. Further, national rules and regulations often require that electrical wiring is made in a shielded and protected fashion, such as in special types of wiring ducts, conduits and the like. Hereby, the wiring process becomes even more cumbersome and expensive. Still further, the old float and tape systems often have fixed installations inside the tank and in the tank roof, which are difficult to replace, and which may prevent installation of a radar system. The net result is that these transition costs often prevent upgrading of existing old float and tape systems.

There is therefore a need for a radar level gauge system that can replace old mechanical level gauging systems, and whereby the installation becomes less cumbersome and/or less expensive.

### SUMMARY OF THE INVENTION

It is therefore an object of the present invention to provide a radar level gauge system that alleviates the above-discussed problems of the prior art.

This object is achieved with a radar level gauge system according to the appended claims.

According to the invention there is provided a radar level gauge system for determining a filling level of a filling material in a tank, said tank having a tank height extending between a base and a roof of said tank. The radar level gauge system comprises:

a wave guide arranged within said tank;

a signaling unit arranged outside said tank, and comprising a transmitter for transmitting measuring signals towards the surface of the filling material in said wave guide and a receiver for receiving echo signals from the tank;

a coaxial cable for forwarding said measuring signals and said echo signals between said wave guide and said signaling unit, wherein said coaxial cable is of a length which is at least as long as said tank height; and

processing circuitry coupled to said signaling unit for determining the filling level of the tank based on said echo signals received by said receiver.

The present inventors have realized that it is possible to use a conventional radar level gauging system for replacing old mechanical systems, by separating the signaling unit from the wave guide within the tank, instead of the conventional solution of arranging the signaling unit close on the antenna roof close to the interior wave guide. Hereby, significant and unexpected advantages have been obtained.

Due to the provision of this very long coaxial cable, it becomes possible to arrange the signaling unit, comprising the microwave electronics, far away from the wave guide within the tank. For example, it hereby becomes possible to arrange the signaling unit outside the tank and close to the tank base, e.g. at the position where the housing of a mechanical float and tape system is normally arranged. The provision of electrical wiring to this position is normally relatively easy and inexpensive to provide, especially in case an existing mechanical system is to be replaced. Further, the coaxial cable may be arranged in pre-existing in-line tube assemblies or the like, which makes the installation process extremely simple and inexpensive. Further, since the power transmitted through the coaxial cable is normally relatively low, and since the coaxial cable is well shielded, no additional shielding or protection is normally required.

The processing circuitry is arranged to determine the filling level of the tank based on the received echo signals e.g. based on a relation between the measuring signals and the received echo signals, as is per se known in the art.

Still further, the measuring signals transmitted through the coaxial cable are preferably of a frequency below 3 GHz, and most preferably below 2 GHz, whereby it becomes possible to use conventional coaxial cables, which are commercially available to a relatively low cost.

The coaxial cable is of a length which is at least as long as the tank height, which e.g. enables placement of the signaling unit close to the ground outside the tank, and preferably at a height approximately in level with the base of the tank. Preferably, the signaling unit is arranged at a height within two meters from the base level of the tank. Further, in a preferred embodiment, the coaxial cable is at least 5 meters, and most preferably at least 10 meters.

As an interior wave guide within the tank, it is possible to reuse guiding structures for the float of the old mechanical systems, such as still pipes or wires, vertically arranged between the tank bottom and the tank roof.

In one embodiment, the wave guide is a surface wave guide, and preferably an uninsulated and unshielded conductor, such as a common uninsulated electric wire. For example, a metallic wire previously used as a guide wire for a float in a mechanical system may be used to this end. In this line of embodiments, an impedance matching is preferably provided between the coaxial cable and the surface wave guide.

Alternatively, the wave guide may be a wave guide tube, such as a vertical still pipe. For example, a still pipe previously used as a guide for a float in a mechanical system may be used to this end. In this line of embodiments, an antenna is preferably provided for transferring signals between the coaxial cable and the wave guide.

The radar level gauge system transmit electromagnetic waves toward the material being monitored through the wave guide and receive electromagnetic echoes which are reflected at the surface of the material being monitored. The gauge system could either use continuous transmitted signals, so-called FMWC (frequency modulated continuous wave) or pulsed transmitted signals. The principles of such radar level gauge systems are per se previously known, and e.g. disclosed in WO 2004/018978 and U.S. Pat. No. 6,414,625, which are hereby incorporated by reference.

These and other aspects of the invention will be apparent from and elucidated with reference to the embodiments described hereinafter.

### BRIEF DESCRIPTION OF THE DRAWINGS

For exemplifying purposes, the invention will be described in closer detail in the following with reference to embodiments thereof illustrated in the attached drawings, wherein:

FIG. 1 is a schematic overview of a conventional mechanical float and tape system;

FIG. 2 is a schematic overview of a radar level gauge system according to a first embodiment of the invention; and

FIG. 3 is a schematic overview of a radar level gauge system according to a second embodiment of the invention.

### DESCRIPTION OF PREFERRED EMBODIMENTS

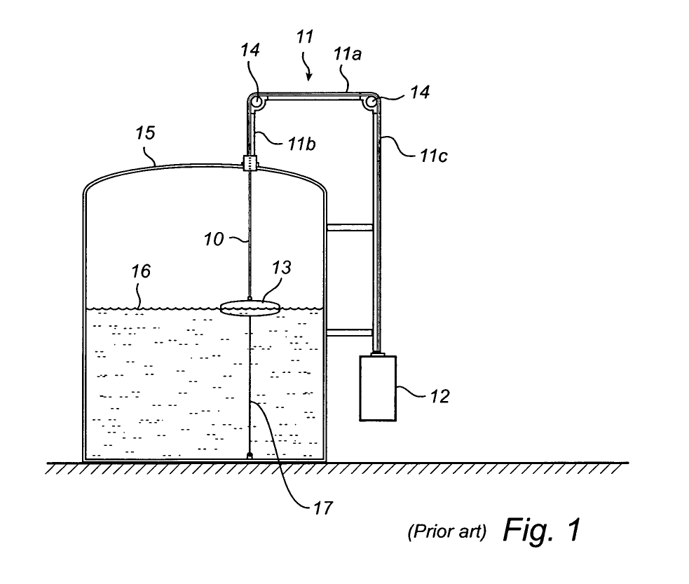

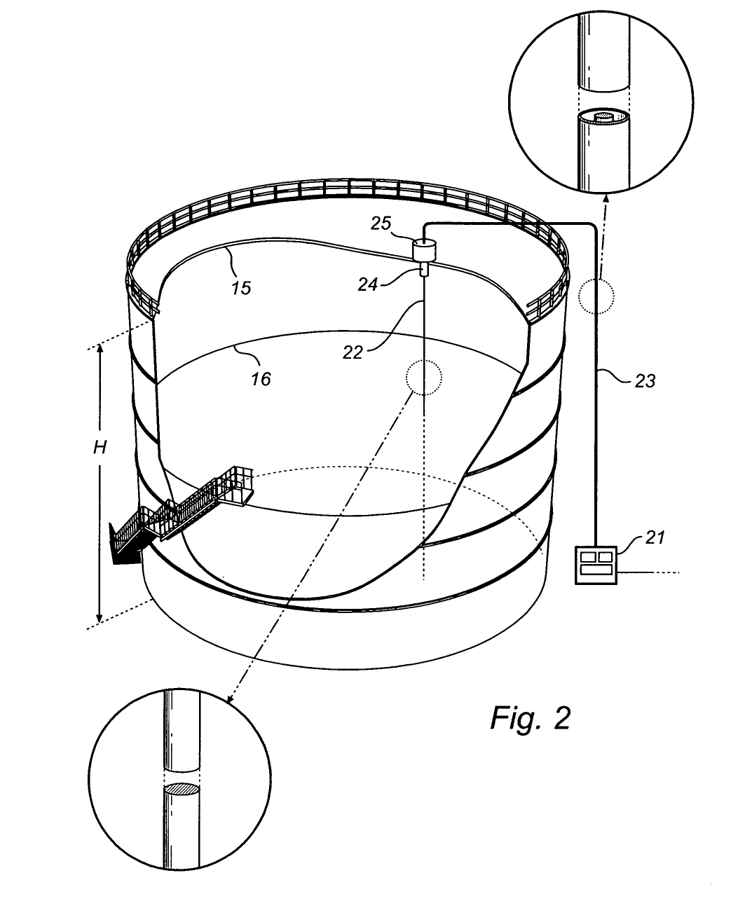

FIG. 2 shows schematically a radar level gauge system according to a first embodiment. In brief, the system in FIG. 2 comprises a signaling unit 21 for transmitting and receiving radar signals and processing the received signals in order to determine the level 16 of a filling material in the tank 15. The signaling unit 21 is arranged outside the tank, and preferably close to the ground level. This position typically corresponds to the location of the housing 12 of a mechanical system, as discussed with reference to FIG. 1. A wave guide 22 is arranged within the tank, and extending vertically between the tank roof and the bottom. The tank is of a height H between the base and the roof of the tank.

The signaling unit 21 houses a transmitter for transmitting measuring signals towards the surface of the filling material in said wave guide and a receiver for receiving echo signals from the tank, as is per se known in the art. Further, the transmitter is preferably arranged to provide measuring signals of a frequency below 3 GHz, and most preferably within the range 1-2 GHz.

The signaling unit is preferably connected to a remote host, for transfer of data signals indicating the filling level of the tank. Processing circuitry for determining the filling level of the tank based on the echo signals received by the receiver in the signaling unit may be arranged within the signaling unit, or outside the signaling unit, e.g. at a remote location, and coupled to the signaling unit.

Further, a coaxial cable 23 is arranged between the signaling unit 21 and the wave guide 22, for forwarding measuring signals and echo signals between the wave guide and the signaling unit. In order to allow the above-discussed separation of the wave guide and the signaling unit, the coaxial cable is of a length which is at least as long as said tank height. For typical tanks, this corresponds to a length of at least 5 meters, and normally the length is at least 10 meters.

In this first embodiment, the wave guide is a surface wave guide, and preferably an uninsulated and unshielded conductor, such as a common uninsulated electric wire. For example, a metallic wire previously used as a guide wire for a float in a mechanical system may be used to this end. In this line of embodiments, an impedance matching 24 is preferably provided between the coaxial cable and the surface wave guide. Communication between the interior and exterior of the tank may be accomplished by a tank roof opening 25, whereby the transition may be achieved through the coaxial cable protruding into the tank, or through the impedance matching element 24.

The impedance matching element may be formed directly on the end of the coaxial cable, whereby the outer shield may be removed and the insulation be formed into a conical part, narrowing down to the point where the inner conductor is connected to the wave guide. However, other types of impedance matching elements may also be used.

In use, the signaling unit 21 transmits radar energy through the coaxial cable 23 and the impedance matching element 24, through the tank roof port 25, and then along the waveguide 22 and receives reflected energy from the liquid surface 16 to provide an indication of the level of the liquid within the tank. The signaling unit could be coupled to a remote location (for example a control room) via a signal wire or the like.

The system may use pulsed or continuously emitted radiation. In case pulsed signals are used, the signals can be DC pulses with a length of about 2 ns, at average power levels in the nW or μW area. Alternatively, the pulses are modulated on a carrier wave of a GHz frequency, but not exceeding 3 GHz. If required, the tank is provided with a sealing, arranged to allow the electromagnetic signals to pass through the wall of the tank while maintaining an air tight seal, so as to prevent tank contents from escaping from the tank.

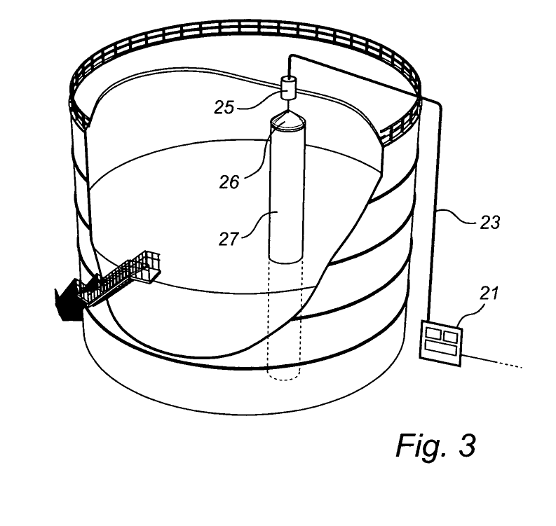

An alternative embodiment is illustrated in FIG. 3. This embodiment generally correspond to the previously discussed first embodiment, but with the below discussed differences.

In this embodiment, the wave guide is a wave guide tube 27, such as a vertical still pipe. For example, a still pipe previously used as a guide for a float in a mechanical system may be used to this end. Further, an antenna 26 is arranged above the still pipe, for transferring signals between the coaxial cable and the wave guide. Thus, the antenna 26 is arranged for transmitting and receiving radar waves into the wave guide. The same antenna could preferably be used both as a transmitter for emitting the output radiation and as a receiver for receiving the reflected echo signal, even though it is also possible to use separate antennas for these functions.

The processing circuitry may operate in various ways for determining the filling level of the tank based on the received echo signals, as is per se well known in the art. For example, this determination can be made by means of a comparison and evaluating of the time difference between transmitted and reflected beam in a calculation and controlling unit, which is per se well known in the art. Various radar principles may be employed for the radar level gauge. One of these is the impulse delay method (pulse radar method), another is the frequency modulated continuous wave (FMCW) radar method. In the FMCW radar method, the delay is determined in an indirect manner by transmitting a frequency modulated signal and creating a difference between the transmitted and the received momentary frequency. The pulse radar method, on the other hand, uses the radiation of short microwave pulses, also known as bursts, wherein the direct time duration is determined between the transmission and the reception of the individual pulses. The received signals can be processed by a processor with software for analyzing the signals in order to determine the filling level, and the processor is preferably a microprocessor based circuit. The functions and algorithms implemented by said signal processor, some of which can be embodied in hardware and some of which can be embodied in software, are per se known from the art will not be discussed further in this application.

In the determination of the filling level of the tank, the processing circuitry preferably uses a compensation for the length of the coaxial cable. Such a compensation may involve a fixed compensation, based on a predetermined estimation or measurement of the cable length. Further, the compensation may be dependent on variable parameters. Such variable compensation may involve temperature compensation, based on the output from a temperature sensor, and/or a normalization of the measurement result based on a known reflex, such as the transition between the coaxial cable and the waveguide.

Specific embodiments of the invention have now been described. However, several alternatives are possible, as would be apparent for someone skilled in the art. For example, different types of signaling units, wave guides and transition elements may be used. Such and other obvious modifications must be considered to be within the scope of the present invention, as it is defined by the appended claims. It should be noted that the above-mentioned embodiments illustrate rather than limit the invention, and that those skilled in the art will be able to design many alternative embodiments without departing from the scope of the appended claims. The word “comprising” does not exclude the presence of other elements or steps than those listed in the claim. The word “a” or “an” preceding an element does not exclude the presence of a plurality of such elements. Further, a single unit may perform the functions of several means recited in the claims.

1. A radar level gauge system for determining a filling level of a filling material in a tank, said tank having a tank height extending between a base and a roof of said tank, comprising:
a wave guide arranged within said tank;
a signaling unit arranged outside said tank, and comprising a transmitter for transmitting measuring signals towards the surface of the filling material in said wave guide and a receiver for receiving echo signals from the tank;
a coaxial cable for forwarding said measuring signals and said echo signals between said wave guide and said signaling unit, wherein said coaxial cable is of a length which is at least as long as said tank height; and
processing circuitry coupled to said signaling unit for determining the filling level of the tank based on said echo signals received by said receiver.

2. The radar level gauge system of claim 1, wherein the wave guide is a surface wave guide.

3. The radar level gauge system of claim 2, wherein the surface wave guide is an unshielded and uninsulated conductor.

4. The radar level gauge system of claim 2, further comprising an impedance matching between the coaxial cable and the surface wave guide.

5. The radar level gauge system of claim 1, wherein the wave guide is a wave guide tube.

6. The radar level gauge system of claim 5, further comprising an antenna for transferring signals between said coaxial cable and said wave guide.

7. The radar level gauge system of claim 1, wherein the transmitter is arranged to provide measuring signals of a frequency below 3 GHz.

8. The radar level gauge system of claim 7, wherein the transmitter is arranged to provide measuring signals of a frequency below 2 GHz.

9. The radar level gauge system of claim 1, wherein the length of the coaxial cable is at least 5 meters.

10. The radar level gauge system of claim 1, wherein the length of the coaxial cable is at least 10 meters.

11. The radar level gauge system of claim 1, wherein the signaling unit is arranged at a height approximately in level with the base of the tank.

12. The radar level gauge system of claim 1, wherein the signaling unit is arranged at a height within two meters from the base level of the tank.

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)
